(19) United States
(12) Patent Application Publication
(10) Pub. No.: US 2013/0339045 A1
(43) Pub. Date: Dec. 19, 2013

(54) SYSTEM AND METHOD FOR OPTIMIZING MEDICATION ORDERING

(71) Applicants: Philip Lockhart, Frisco, TX (US); John Hobson, Newport Beach, CA (US)

(72) Inventors: Philip Lockhart, Frisco, TX (US); John Hobson, Newport Beach, CA (US)

(21) Appl. No.: 13/918,266

(22) Filed: Jun. 14, 2013

Related U.S. Application Data
(60) Provisional application No. 61/660,404, filed on Jun. 15, 2012.

(51) Int. Cl. G06Q 30/06; G06Q 50/22

(52) U.S. Cl. CPC G06Q 30/0631; G06Q 50/22
USPC 705/2

(57) ABSTRACT

The disclosed embodiments include a method, apparatus, and computer program product for optimizing and fulfilling medication orders. For example, in one embodiment, a method for fulfilling medication orders includes receiving information regarding a medication order; receiving a budget amount; performing a search based on the medication order and the budget amount; and displaying results of the search to a user.

### CROSS REFERENCE TO RELATED APPLICATIONS

This application claims priority to U.S. Provisional Patent Application Ser. No. 61/660,404 filed on Jun. 15, 2012 entitled SYSTEM AND METHOD FOR OPTIMIZING MEDICATION ORDERING the entire teachings of which are incorporated herein.

### BACKGROUND OF THE INVENTION

The present invention relates generally to the field of applications for computing devices, such as mobile phones, personal digital assistants, personal computers, laptops, portable media players and the like, and more particularly to a system and method for optimizing and refilling medication orders.

Online pharmacies, Internet pharmacies, or Mail Order Pharmacies are pharmacies that operate over the Internet and send the orders to customers through the mail or shipping companies. However, current online pharmacies lack features that would assist customers in saving money and/or to stay within a budget.

Accordingly, the disclosed embodiments seek to provide a system, method, and computer program product for optimizing and fulfilling medication orders that would overcome some of the deficiencies with current online pharmacies.

### BRIEF SUMMARY OF THE INVENTION

The disclosed embodiments include a method, apparatus, and computer program product for optimizing and fulfilling medication orders. For example, in one embodiment, a method for fulfilling medication orders includes receiving information regarding a medication order; receiving a budget amount; performing a search based on the medication order and the budget amount; and displaying results of the search to a user. The results of the search may include one or more combinations of a plurality of different medications that is purchasable within the budget amount. The results of the search may also provide an optimal or suggested combination. The results of the search may also be based on a user's ranking of the importance of each medication to the user. Still, the results of the search may be further refined based on other user-desired preferences, such as, but not limited to, whether the user desires local pickup and whether the user is open to alternative brands of a medication or a generic brand of a medication.

Additional embodiments, advantages, and novel features are set forth in the detailed description.

### BRIEF DESCRIPTION OF THE DIAGRAMS

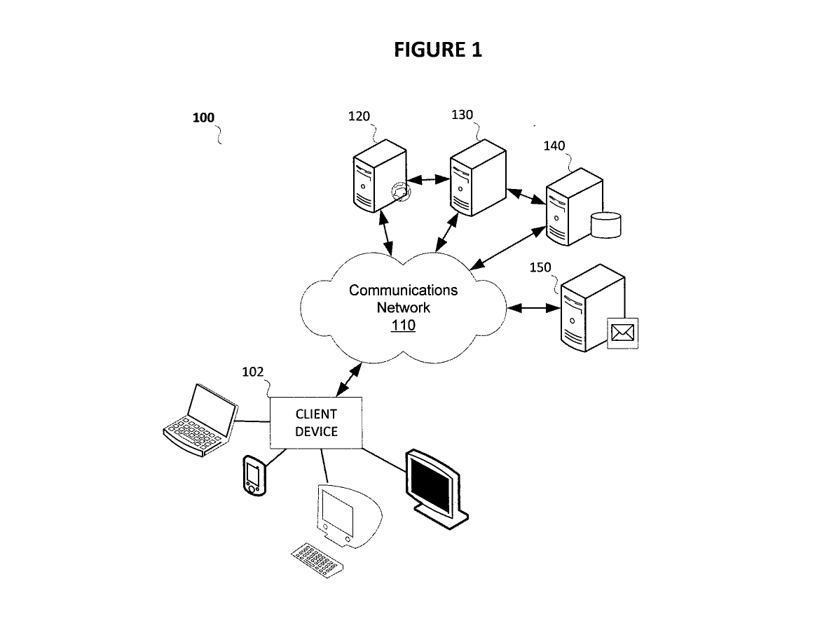

FIG. 1 is a schematic diagram illustrating a network environment in accordance with an embodiment of the invention;

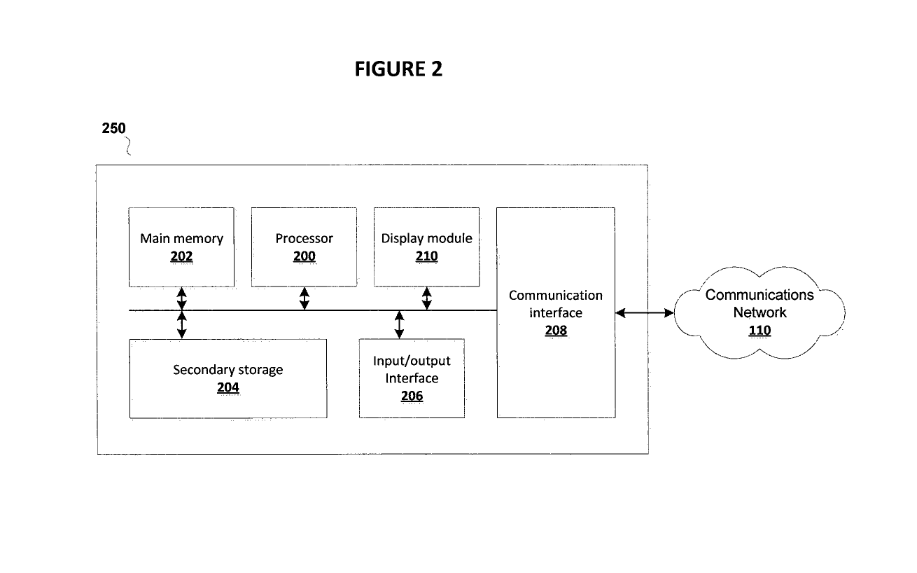

FIG. 2 is a schematic diagram illustrating a device in accordance with an embodiment of the invention;

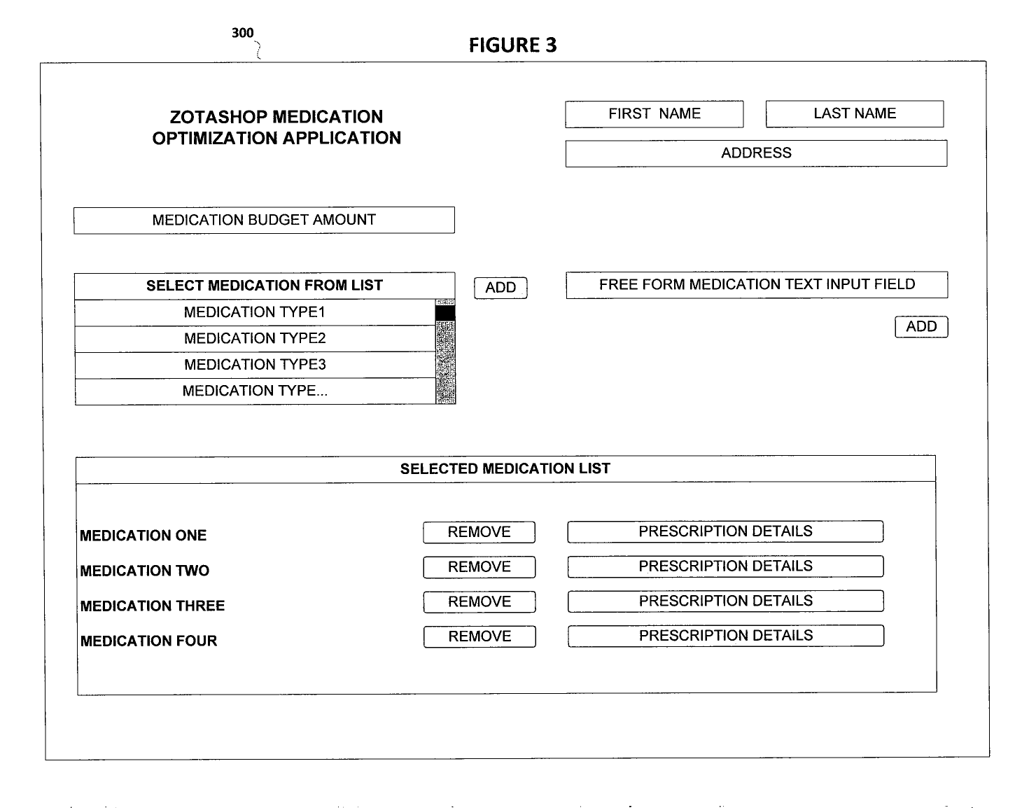

FIG. 3 is a diagram illustrating a user interface of an application in accordance with an embodiment of the invention; and

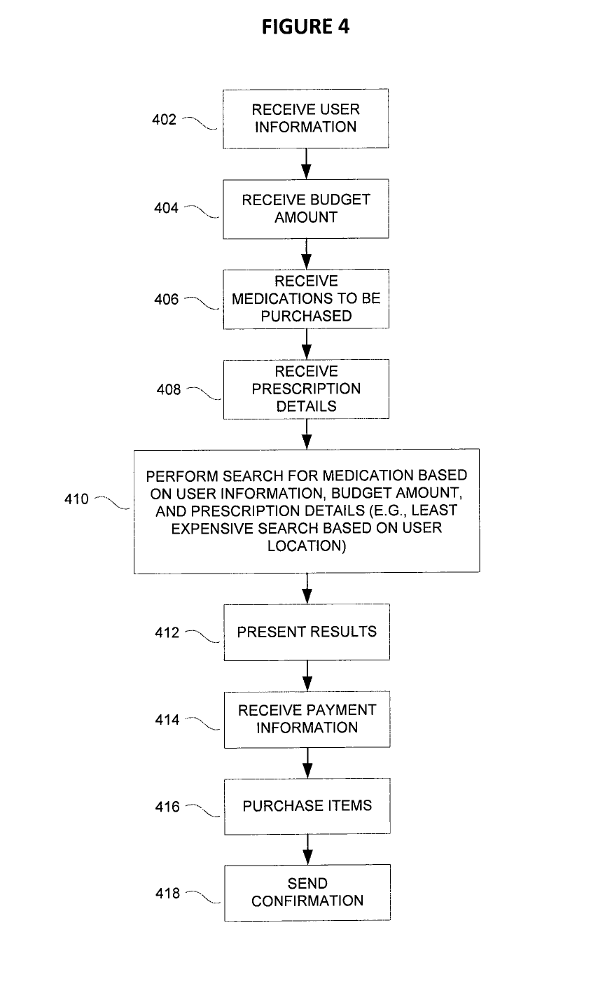

FIG. 4 is a flowchart illustrating a process for placing medication orders in accordance with one embodiment.

### DETAILED DESCRIPTION

The disclosed embodiments may assist a user in budgeting, ordering, and/or finding the least expensive options for fulfilling new or existing medication orders. The disclosed embodiments and advantages thereof are best understood by referring to FIGS. 1-4 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and not intended to assert or imply any limitation with regard to the environment, architecture, design, or process in which different embodiments may be implemented.

FIG. 1 depicts an embodiment of a network environment 100 in which certain illustrative embodiments may be implemented. The network environment 100 includes a communications network 110 that enables a plurality of devices including a user device 102 to communicate data with other devices connected to the communications network 110. The communications network 110 may be any type of network including a wide area network, a local area network, one or more private networks, and the Internet. In some embodiments, communications network 110 may include a telephone network such as the public switched telephone network (PSTN), one or more cellular networks, and/or wireless data networks such as, but not limited to, a 3G/4G network. The communications network 110 may include a plurality of network nodes (not depicted) such as routers, network access points/gateways, switches, DNS servers, proxy servers, and other network nodes for assisting in routing of data/communications between devices.

In the depicted embodiment, the communications network 110 may provide data communications between one or more client devices such as a client device 102 and one or more server devices for enabling a user to fulfill new or existing medication orders. The client device 102 may be any type of device operable to communicate with the one or more servers over the communications network 110. For example, the client device 102 may be a laptop computer, a mobile phone or tablet, a desktop computer, a wired phone, a television, a set-top box, and/or any other device operable to communicate with the one or more servers over the communications network 110 for enabling a user to fulfill new or existing medication orders.

The one or more servers may include one or more Web servers 120, Back-End servers 130, Database servers 140, and Mail servers 150. For example, in one embodiment, a user using the client device 102 interacts with a web site hosted by a Web server 120 in order to fulfill new or existing medication orders. The client device 102 may interact with the Web server 120 utilizing a web browser application. Alternatively, the client device 102 may interact with either the Web server 120 or directly with another server device via an application installed on the client device 102 specially configured to enable a user to fulfill new or existing medication orders. For instance, in some embodiments, a user's mobile device may be configured to include a mobile application and/or a user may download an application and install it on his/her personal computer.

In some embodiments, a Web server 120 may utilize one or more Back-End servers 130 to perform functions associated with enabling a user to fulfill new or existing medication orders. For example, the Back-End servers 130 may perform the actual query searches and provide the results to the Web server 120. The Web server 120 then formats the results into a format that is presentable to the user. Advantages of this configuration include the one or more Back-End servers 130 being able to serve multiple Web servers 120, easier management by splitting the interface code from the labor intensive code, and generally faster processing capabilities of the Back-End servers 130.

The Web server 120 and Back-End servers 130 may also utilize one or more Database servers 140. For example, in one embodiment, the Database servers 140 may store all the medication data such as, but not limited to, pricing, availability, and location information. The Database servers 140 may also store user information such as, but not limited to, a user profile, user medication history, user preferences, and user billing information. The Web server 120 and/or Back-End servers 130 may also communicate with one or more communications servers such as, but not limited to, a Mail server 150, an SMS server (not depicted), and a fax server for sending and receiving communications.

In one embodiment, the Web servers 120, Back-End servers 130, and Database servers 140 may communicate over the communications network 110. This communication may be over the Internet and/or over a private network. In some embodiments, one or more of the above server devices may be directly wired to each other to provide direct communications between the devices. Still, in some embodiments, a single server/device may be configured to perform all functions for enabling a user to fulfill new or existing medication orders.

For example, FIG. 2 depicts a schematic diagram illustrating some components of a server device 250 in accordance with the disclosed embodiments for enabling a user to fulfill new or existing medication orders. The server device 250 includes a processor 200, main memory 202, secondary storage unit 204, an input/output interface module 206, and a communication interface module 208. The processor 200 may be any type of processor capable of executing instructions for performing functions associated with the server device 250 and the functions associated with enabling a user to fulfill new or existing medication orders in accordance with the disclosed embodiments.

The input/output interface module 206 enables the server device 250 to receive user input and output information to a user or other devices. In some embodiments, the input/output interface module 206 also provides audio and video capabilities. The input/output interface module 206 may also enable external devices such as printers, USB flash drive, speakers, to be connected to the server device 250.

The communication interface module 208 enables the server device 250 to communicate with the communications network 110. For example, the network interface module 208 may include a network interface card for hardwiring the server device 250 to the communications network 110. In one embodiment, the communication interface module 208 may also include a wireless data interface for enabling the server device 250 to communicate wirelessly through a wireless access point or via a wireless network with the communications network 110. In some embodiments, the communication interface module 208 may also include a radiofrequency transceiver for sending and receiving cellular signals for voice communications.

In some embodiments, the server device 250 may optionally include a display module 210 to enable information to be displayed on an internal or external display device. For instance, the display module 210 may include instructions or hardware for providing touchscreen capabilities for receiving user input via the display device. In certain embodiments, the display module 210 may also enable multi-touch functionalities associated with the display device.

Main memory 202 is volatile memory that stores currently executing instructions/data, or instructions/data that are prefetched for execution. The secondary storage unit 204 is non-volatile memory for storing persistent data. The secondary storage unit 204 may be or include any type of data storage component such as a hard drive, a flash drive, or memory card. In one embodiment, the secondary storage unit 204 includes an application or computer executable code/instructions for enabling a user to fulfill new or existing medication orders. These instructions are passed from the secondary storage unit 204 to main memory 202 for enabling execution by the processor 200.

In accordance with the disclosed embodiments, example computer executable instructions include instructions for generating a user interface, instructions for parsing information received from a user, instructions for performing a search to identify medication satisfying a search criteria (e.g., based on user information, budget amount, and prescription details and/or searching for least expensive option), presenting the search results, and placing orders to fulfill the user's medication needs. The computer executable instructions may also include instructions for storing/retrieving a user's medical and/or medication history, storing user profile information, and billing information.

As an example, FIG. 3 depicts a diagram illustrating a user interface 300 of an application in accordance with an embodiment. The user interface 300 may include text input fields, pull down list options, and buttons for receiving or triggering one or more features of a medication optimization application in accordance with a disclosed embodiment. For example, the user may enter user information such as, but not limited to, name and address in one or more text fields. In this particular embodiment, the user interface 300 may also include a field for receiving a medication budget amount (e.g., $150 per month). In the depicted embodiment, the user may select particular medications from a pull down list and/or may enter a medication into a text field. The system may be configured to search for an exact match or closest match to the entered text.

The user interface 300 may also display a list of selected medication with the options of enabling a user to remove a particular listed item and/or provide additional prescription details regarding a particular listed item. For example, in response to receiving a prescription details user-input (i.e., user presses the button on the interface), a second interface window may be presented that enables a user to provide details regarding a particular selected prescription, such as, but not limited to, a number of pills per refill, whether to utilize generic medication if available, whether to automatically refill, and if so, the refill period/duration, and whether the user desires to locally pick up the particular medication or have it shipped (may also include shipping preferences, for example expedited, first-class, regular mail, UPS, Fed-Ex, etc.)

Once all the user information is collected, a search is performed to identify medication/pricing to satisfying the list of selected medications. The search may include a search criteria based on the budget amount and prescription details. Alternatively, in some embodiments, the search criteria may be based on finding the least expensive option that satisfies the list of medications. In one embodiment, the search results are presented on a new interface/screen (i.e., a results screen). The results screen may list out medications and corresponding price, quantity, and location information. In some embodiments, the results screen may include an option to search for an alternative medication. This option may be performed on an individual user-selected medication or may be performed simultaneously on the entire list of medications. Once the user is satisfied with the presented results, the user may proceed to checkout and place the order to fulfill the list of medications.

In particular embodiments, the system may save the users medication ordering history, billing information, shipping information, and other user information for future orders and for providing reminder notifications.

An example method/process for fulfilling new or existing medication orders in accordance with one embodiment is illustrated in a flowchart depicted in FIG. 4. FIG. 4 begins by receiving user information at step 402 such as, but not limited to, a user name, address, and other account information. At step 404, the process receives a budget amount indicating the amount of money that a user has to spend on the list of medications. At step 406, the process receives medication information such as a list of medications to purchase. The process may receive additional information regarding each medication at step 408, such as, but not limited to, a number of pills, how many milligrams per pill, the duration per refill, whether to automatically refill, when a prescription ends, whether to utilize generic brand medications if available, and whether to search locally for local pickup. In addition, in some embodiments, the user may rank the medical necessity of certain medications as having a higher priority than other medications.

Once all the information is gathered, the process, at step 410, performs a search using a search criteria based on the user entered information, budget amount, and prescription details. Alternatively, in some embodiments, the process may simply search for the least expensive options that satisfy the list of medications. At step 412, the results of the query including the list of medications and corresponding detailed information (e.g., price, location, quantity, and any alternative options) are presented to the user. In certain embodiments, the results of the query include one or more combinations of the plurality of different medications that is purchasable within the budget amount. The results of the query may also provide an optimal combination of the plurality of different medications that is purchasable within the budget amount.

At this point, in certain embodiments, the process may provide options for enabling the user to alter the search results/search query such as, but not limited to switching between online and local pickup, switching to an alternative medication, changing quantities of a particular medication, and changing to a generic or a brand-name medication. In certain embodiments, the process may also enable the user to view the least expensive option, to view a suggested option, and/or to view a preferred option based on other user recommendations and/or doctor recommendations.

At step 414, the process receives and stores payment information (also shipping information if not already determined). At step 416, process places the orders on behalf of the user for the medications at/with the providers corresponding to each of the selected medications utilizing the customer payment information. In some embodiments, part of placing the order includes faxing or e-mailing a copy of a prescription to the medication provider. The process ends at step 418 the sending a confirmation message such as an e-mail or text message to the user indicating that the medication order is placed and providing any available shipping information.

Accordingly, the above disclosure describes a novel and inventive system and method for enabling a user to fulfill medication needs all in one place while staying within a specified budget. Alternatively, the disclosed embodiments enable the user to find the lowest priced medications satisfying a user's particular search criteria.

The illustrative embodiments can take the form of an entirely hardware embodiment, an entirely software embodiment or an embodiment containing both hardware and software elements. Furthermore, the illustrative embodiments can take the form of a computer program product accessible from a computer-usable or computer-readable medium providing program code for use by or in connection with a computer or any instruction execution system. For the purposes of this description, a computer-usable or computer-readable medium can be any tangible non-transitory apparatus that can store the program for use by or in connection with a system or electronic device.

The previous detailed description is of a small number of embodiments for implementing the invention and is not intended to be limiting in scope. For example, while specific details about the above embodiments have been described, the above hardware and software descriptions are intended merely as example embodiments and are not intended to limit the structure or implementation of the disclosed embodiments.

In addition, those skilled in the art will recognize that the present teachings are amenable to a variety of modifications and/or enhancements. While the foregoing has described what is considered to be the best mode and/or other examples, it is understood that various modifications may be made therein and that the subject matter disclosed herein may be implemented in various forms and examples, and that the teachings may be applied in numerous applications, only some of which have been described herein. Such modifications are intended to be covered within the true scope of the present teachings.

In addition, the flowcharts, sequence diagrams, and block diagrams in the figures illustrate the architecture, functionality, and operation of possible implementations of systems, methods and computer program products according to various embodiments of the present invention. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described to explain the principles of the invention and the practical application, and to enable others of ordinary skill in the art to understand the invention for various embodiments with various modifications as are suited to the particular use contemplated. The scope of the claims is intended to broadly cover the disclosed embodiments and any such modification.

1. A method for fulfilling medication orders, the method comprising:
receiving information regarding a medication order;
receiving a budget amount;
performing a search based on the medication order and the budget amount; and
displaying results of the search to a user.

2. The method of claim 1, wherein the medication order comprises a plurality of different medications and wherein the results of the search include one or more combinations of the plurality of different medications that is purchasable within the budget amount.

3. The method of claim 1, wherein the medication order comprises a plurality of different medications and wherein the results provide an optimal combination of the plurality of different medications that is purchasable within the budget amount.

4. The method of claim 1, wherein performing the search includes identifying medications available at a location local to the user.

5. The method of claim 4, wherein identifying medications available at the location local to the user is performed in response to a user selectable option for local pickup.

6. The method of claim 1, wherein the medication order comprises a plurality of different medications and wherein the results provide a combination of the plurality of different medications that is purchasable within the budget amount that is determined to be most medically necessary based on a user-specified ranking of the plurality of different medications.

7. The method of claim 1, further comprising:
receiving one or more modification of the medication order, budget amount, and user-specified preferences;
performing a new search based on the one or more modification of the medication order, budget amount, and user-specified preferences; and
displaying results of the new search to the user.

8. The method of claim 1, further comprising;
receiving shipping and payment information from the user; and
completing a purchase transaction based on the results of the search.

9. The method of claim 1, wherein performing the search comprises performing a search of a plurality of different medication providers, and wherein the results of the search include medications from one or more of the plurality of different medication providers.

10. The method of claim 8, wherein completing the purchase transaction comprising placing an order to one or more third party medication providers on behalf of the user for fulfilling the purchased transaction.

11. A system comprising:
memory for storing data and executable instructions;
a processor configured to execute the executable instructions to:
receive information regarding a medication order;
receive a budget amount;
perform a search based on the medication order and the budget amount; and
display results of the search to a user.

12. The system of claim 11, wherein the medication order comprises a plurality of different medications and wherein the results of the search include one or more combinations of the plurality of different medications that is purchasable within the budget amount.

13. The system of claim 11, wherein the medication order comprises a plurality of different medications and wherein the results provide an optimal combination of the plurality of different medications that is purchasable within the budget amount.

14. The system of claim 11, wherein performing the search includes identifying medications available at a location local to the user.

15. The system of claim 14, wherein identifying medications available at the location local to the user is performed in response to a user selectable option for local pickup.

16. The system of claim 11, wherein the medication order comprises a plurality of different medications and wherein the results provide a combination of the plurality of different medications that is purchasable within the budget amount that is determined to be most medically necessary based on a user-specified ranking of the plurality of different medications.

17. The system of claim 11, further comprising executable instructions to:
receive one or more modification of the medication order, budget amount, and user-specified preferences;
perform a new search based on the one or more modification of the medication order, budget amount, and user-specified preferences; and
display results of the new search to the user.

18. The system of claim 11, further comprising executable instructions to:
receive shipping and payment information from the user; and
complete a purchase transaction based on the results of the search, wherein completing the purchase transaction comprising placing an order to one or more third party medication providers on behalf of the user for fulfilling the purchased transaction.

19. The system of claim 11, wherein performing the search comprises performing a search of a plurality of different medication providers, and wherein the results of the search include medications from one or more of the plurality of different medication providers.

20. A non-transitory computer readable medium comprising computer executable instructions that when executed causes one or more machines to perform operations comprising:
receiving information regarding a medication order;
receiving a budget amount;
performing a search based on the medication order and the budget amount; and
displaying results of the search to a user.
